(19) United States
(12) Patent Application Publication
(10) Pub. No.: US 2009/0223096 A1
(43) Pub. Date: Sep. 10, 2009

(54) TOOL IDENTIFICATION

(76) Inventor: Alois Wimmer, Hof bei Salzburg (AT)

Correspondence Address: HENRY M FEIEREISEN, LLC;HENRY M FEIEREISEN, 708 THIRD AVENUE, SUITE 1501, NEW YORK, NY, 10017, US

(21) Appl. No.: 12/294,147

(22) PCT Filed: Mar. 15, 2007
(86) PCT No.: PCT/AT2007/000127

§ 371 Date: Sep. 23, 2008

(30) Foreign Application Priority Data
Mar. 23, 2006 (AT) GM226/2006

(51) Int. Cl. E02F 3/96; G08B 21/00

(52) U.S. Cl. 37/468; 340/686.1

(57) ABSTRACT

A quick-action coupling for coupling a tool to a bracket of a construction machine includes complementary coupling elements arranged on each of the tool and on the end of the bracket. The coupling elements can be used to connect, for example, hydraulic lines to drive equipment attached to the tool. The tool includes an identification carrier for identifying the tool, and the bracket includes one or several detectors, which are connected with a controller of the hydraulics of the construction machine. Projections, pins or the like, which are arranged on the tool or on the coupling element in a grid pattern, engage with switches, sensors or the like mounted on the bracket and arranged in an identical grid pattern. The tool is identified through the pattern of the projections or pins on the tool or on the coupling element attached to the tool.

The invention relates to a rapid-action coupling for coupling a tool to the bracket of a construction machine, wherein a respective coupling element is provided on each of the tool and on the end of the bracket, wherein energy lines, in particular hydraulic lines for driven equipment disposed on the tool, can also be coupled with the coupling elements, and wherein an identification carrier for identifying the tool is provided on the tool and one or several detectors for identifying the received tool, which are connected with the controller of the hydraulics of the construction machine, are provided on the bracket of the construction machine.

With couplings of this type, the hydraulic supply must be connected following the instructions of the tool manufacturer, wherein the correct quantity of oil and the correct pressure must be set on the support device. With modern hydraulic excavators, this can be attained using the control electronics installed in the modern construction machines via the stored program selection. Typically, between 3 and 10 different settings are available, which are associated with the respective tool type.

To prevent the user from selecting wrong programs and/or to speed up the coupling operation, a conventional embodiment (EP 1 375 757) already proposes to install a transponder on the tool, which can be read out with a reading device provided on the end of the excavator boom, wherein the read out data are transmitted to the control electronics of the construction machine. In this embodiment, both the transponder and the electronic reading devices are disadvantageously sensitive components, which can be easily damaged or rendered inoperative by rough handling, as is typically the situation at a construction site, with the erroneous control potentially causing damage to the tool or the attached equipment.

It is an object of the invention to construct a quick-acting coupling of the aforedescribed type, so that the coupling operates reliably also under the rough operating conditions at a construction site.

This is attained by the invention in that several projections, pins or the like, which are arranged in a grid pattern, are provided on the tool or on the coupling element disposed on the tool, and that sensors, switches or the like, which can be actuated by the projections, pins or the like, with an identical grid pattern are provided as detectors on the bracket of the construction machine or on the coupling element mounted on the bracket. No electronic or electronically operating components are thus arranged on the tool, while the detectors provided on the end of the bracket of the construction machine can be configured so that they can be readily protected, without incorporating sensitive electronic components.

Advantageously, the sensors can be implemented as contactless operating proximity sensors, thereby eliminating mechanical stress during the coupling process. Such contactless operating proximity sensors can be implemented as capacitive, inductive or optical sensors or as sensors implemented in ultrasound technology, wherein the corresponding sensor is activated when the pins or the projections in the grid pattern approach. In a simplified embodiment, the switches can also be mechanical pushbutton switches, whereby the switch impulse is initiated when a corresponding actuating element contacts the pushbutton switch. The detectors can also be recessed in recesses, which provides additional protection against damage or detrimental external mechanical effects.

An exemplary embodiment of the invention is illustrated in the drawing.

FIG. 1 shows the quick-action coupling of the invention in a side view;

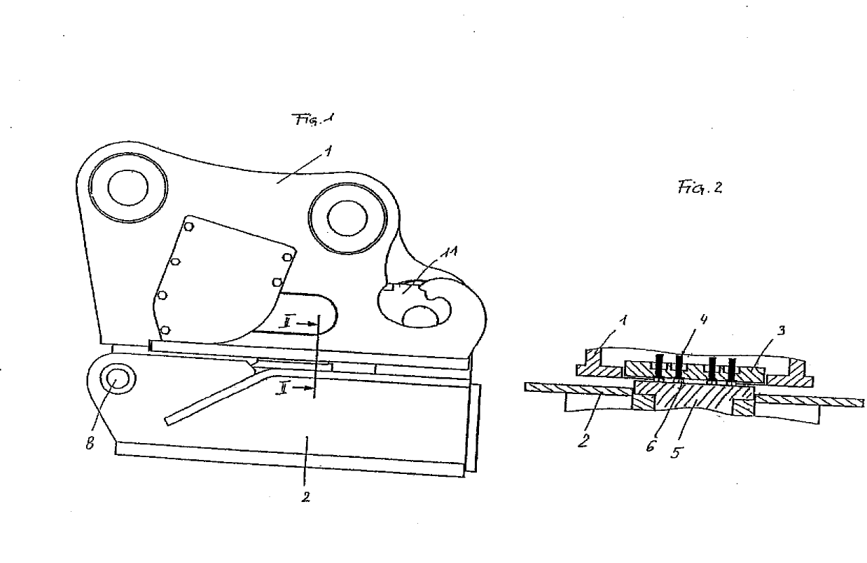

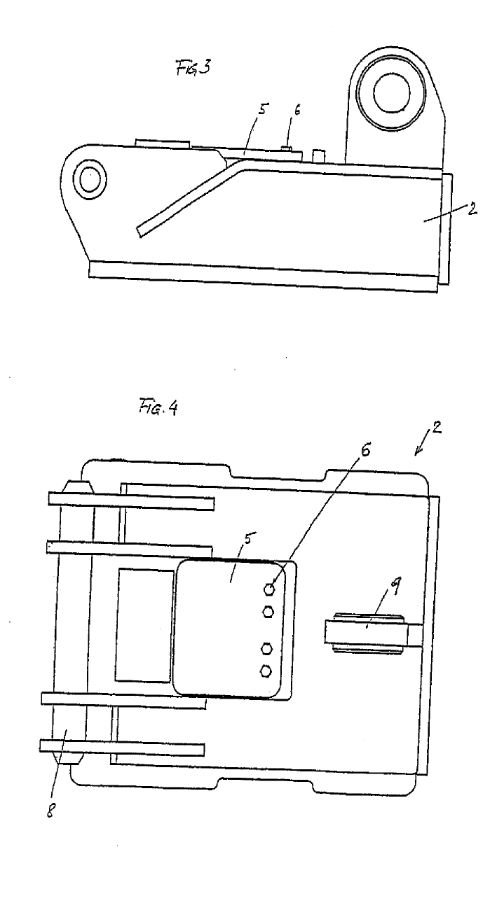

FIG. 2 is a partial cross-section taken along the line II-II of FIG. 1;

FIG. 3 shows in a side view the coupling element mounted on the tool;

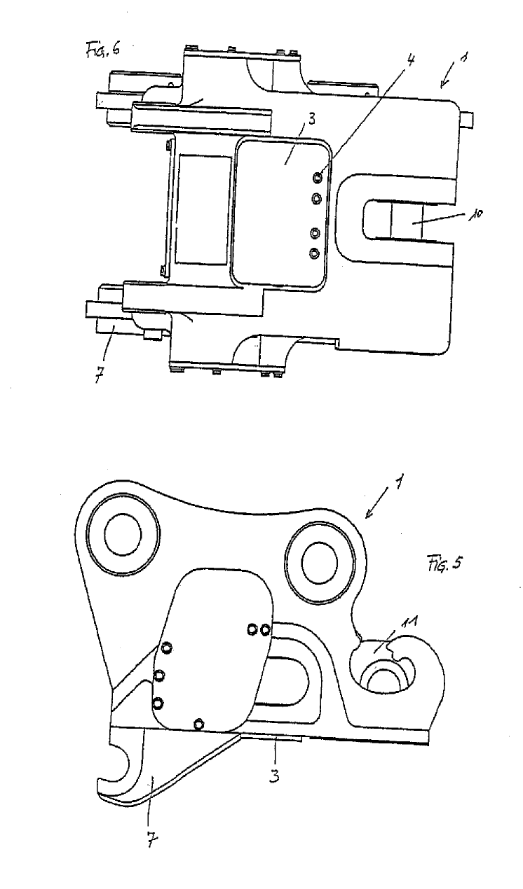

FIG. 4 is a top view onto the coupling element according to FIG. 3;

FIG. 5 shows the coupling element arranged on the bracket in a side view;

FIG. 6 shows the same in a bottom view; and

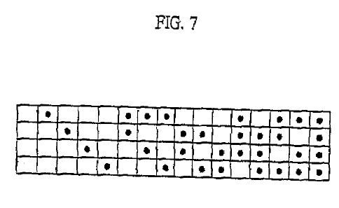

FIG. 7 shows different possibilities for arranging pins and transmitting codes with a four-pin arrangement, wherein each point represents an actual pin and each vertical column represents a possible arrangement of one or more pins for encoding the tool.

The reference symbol 1 indicates schematically the coupling element attached at the end of the bracket of the construction machine, cooperating with a coupling element 2 provided on the tool. This represents a conventional quick-action coupling, wherein the coupling element 1 is provided with hook extensions 7, which hook into corresponding bolts 8 of the coupling element 2 provided on the tool. After the part 1 is lowered onto the coupling element 2, a connecting lug 9 can be interlocked with locking lugs 11 disposed on the coupling element 1 by a connecting bolt. Such connections are, as described above, state-of-the-art and will therefore not be described in detail.

This form of coupling can be used to couple hydraulic lines together with corresponding coupling blocks (not illustrated). Energy is supplied to the hydraulic lines from the bracket via the coupling element 1, with the energy being transmitted via the coupling to the tool and/or the connected machinery.

To indicate to the construction machine the type of tool that is actually coupled, the tool includes a support plate 5 for projections 6, which cooperate with sensors 4 provided on a support plate 3 of the coupling element 1. In the present example, these sensors 4 are implemented as contactless proximity sensors which are capable of detecting if a corresponding projection is located opposite the detection end of the sensor, or not. The details are illustrated in FIG. 2, wherein in the example a projection or pin is provided for each of the sensors, so that all four sensors respond and transmit the corresponding position to the control unit of the construction machine.

Such implementation with four projections or pins are capable of transmitting 16 different identifications, depending how many projections 6 are provided on the support plate 5 of the coupling element 2. The respective position or association of the projections with the sensor is also important. Reference is made to the exemplary embodiment depicted in FIG. 7, wherein the 4 rows indicate the 4 sensors, and the points indicated in the rows illustrate the corresponding position of one or several projections. The embodiment illustrated in FIG. 2 hence corresponds to the location of the projections depicted in the last row of FIG. 7. Each row therefore represents a special program for controlling the tools, wherein the corresponding program is selected by the control electronics based on the identification transmitted by the projections or pins.

The proximity sensors can be implemented either as capacitive or inductive sensors, wherein the sensors are selected according to the specific application. However, inductive sensors are more robust in operation, because the sensors are less affected by detrimental external influences. To eliminate all environmental effects, mechanical pushbutton switches can be used which respond only to the force applied via the pins.

The detectors or sensors 4 can be recessed in recesses of the respective support plate 3 (not illustrated), thereby eliminating mechanical effects from foreign material and the like during a changeover. However, the projections or pins would then need to enter the recesses to sufficient depth.

1-5. (canceled)

6. A rapid-action coupling for coupling a tool to a bracket of a construction machine, comprising:
a first coupling element provided on the tool and having an identification carrier for identifying the tool, said identification carrier comprising a plurality of projections arranged in a grid pattern, and a second coupling element provided on an end of the bracket and having a plurality of detectors rendered operative by the projections, when arranged in a grid pattern matching the grid pattern of the projections, and connected to a controller of the construction machine for identification of the tool coupled to the bracket.

7. The rapid-action coupling of claim 6, wherein the detectors are configured as sensor or switch.

8. The rapid-action coupling of claim 6, wherein the first and second coupling elements are configured to couple energy-transmitting lines for driving equipment disposed on the tool.

9. The rapid-action coupling of claim 8, wherein the energy-transmitting lines are hydraulic lines.

10. The rapid-action coupling of claim 8, wherein the controller controls a hydraulics of the construction machine.

11. The rapid-action coupling of claim 7, wherein the sensor is a contactless operating proximity sensor.

12. The rapid-action coupling of claim 11, wherein the proximity sensor is a member selected from the group consisting of capacitive sensor, inductive sensor, optical sensor, and sonic transducer embodied in ultrasound technology.

13. The rapid-action coupling of claim 7, wherein the switch is a mechanical pushbutton switch.

14. The rapid-action coupling of claim 6, wherein the second coupling element has a support plate formed with recesses for receiving the detectors in one-to-one correspondence.

15. The rapid-action coupling of claim 6, wherein the projections are pins.
